(19) United States
(12) Patent Application Publication
(10) Pub. No.: US 2024/0352638 A1
(43) Pub. Date: Oct. 24, 2024

(54) METHOD AND SYSTEM FOR DETERMINING AND ESTIMATED TIME REMAINING FOR A DRYER SYSTEM

(71) Applicant: Whirlpool Corporation, Benton Harbor, MI (US)

(72) Inventors: Victor Jafet Vargas, Stevensville, MI (US); Chetan C. Ajabe, Pune (IN); Roy E. Masters, JR., Saint Joseph, MI (US)

(21) Appl. No.: 18/138,463

(22) Filed: Apr. 24, 2023

(51) Int. Cl. D06F 34/06; D06F 34/26; D06F 34/32; D06F 58/20; D06F 58/38; D06F 58/46; G06N 3/044; G06N 3/08

(52) U.S. Cl. CPC D06F 34/06; D06F 34/26; D06F 34/32; D06F 58/20; D06F 58/38; D06F 58/46; G06N 3/044; G06N 3/08; D06F 2103/32; D06F 2103/34; D06F 2103/38; D06F 2105/56; D06F 2105/58

(57) ABSTRACT

A laundry appliance includes a cabinet having a laundry compartment located inside said cabinet, an exhaust vent extending from the laundry compartment, an exhaust temperature sensor disposed in the exhaust vent generating an exhaust temperature signal, an exhaust humidity sensor disposed in the exhaust vent generating an exhaust humidity signal and an ambient humidity sensor generating an ambient humidity signal. The appliance further includes a display and a controller coupled to the exhaust temperature sensor, the exhaust humidity sensor and the ambient humidity sensor. The controller determines an estimated time remaining for a drying cycle based on the exhaust temperature signal, the exhaust humidity signal and the ambient humidity signal and causes the display to display the estimated time remaining.

### FIELD

The present disclosure relates generally to laundry appliances and more particularly to a method and system for determining an estimated drying time.

### BACKGROUND

The statements in this section merely provide background information related to the present disclosure and may not constitute as prior art.

Laundry appliances (i.e., laundry machines, washing machines, and dryers) are prolific in both residential and commercial settings. For dryers, the estimated time remaining (ETR) in the dry cycle is displayed on a front panel of the laundry machine. The estimated time remaining is calculated for the dry cycle to finish. Oftentimes, the calculation is merely based upon a moisture sensor that senses the amount of moisture within the laundry compartment. The amount of moisture within the laundry compartment may vary significantly depending upon the amount of load. The estimated time remaining actually takes a lot longer than the displayed estimated time. This is true for both standalone dryers and for a combination appliance where a single machine performs both the washing and drying functions.

### SUMMARY

This section provides a general summary of the disclosure, and is not a comprehensive disclosure of its full scope or all of its features.

In accordance with one aspect of the present disclosure, a laundry appliance includes a cabinet having a laundry compartment located inside said cabinet, an exhaust vent extending from the laundry compartment, an exhaust temperature sensor disposed in the exhaust vent generating an exhaust temperature signal, an exhaust humidity sensor disposed in the exhaust vent generating an exhaust humidity signal and an ambient humidity sensor generating an ambient humidity signal. The appliance further includes a display and a controller coupled to the exhaust temperature sensor, the exhaust humidity sensor and the ambient humidity sensor. The controller determines an estimated time remaining for a drying cycle based on the exhaust temperature signal, the exhaust humidity signal and the ambient humidity signal and causes the display to display the estimated time remaining.

In another aspect of the disclosure, a method of operating a laundry appliance having a laundry compartment and an exhaust vent extending from the laundry compartment is set forth. The method includes generating an exhaust temperature signal from an exhaust temperature sensor disposed in the exhaust vent, generating an exhaust humidity signal from an exhaust humidity sensor disposed in the exhaust vent, generating an ambient humidity signal from an ambient humidity signal, determining an estimated time remaining for a drying cycle based on the exhaust temperature signal, the exhaust humidity signal and the ambient humidity signal and displaying the estimated time remaining on a display.

Other features include a timer generating an elapsed time since starting of the drying cycle and the controller determining the estimated time remaining based on the elapsed time, the exhaust humidity sensor generating an exhaust humidity signal corresponding to an exhaust humidity ratio and the ambient humidity sensor generating an ambient humidity signal corresponding to an inlet humidity ratio, the controller generating a difference of the exhaust humidity ratio and the ambient humidity ratio and determining the estimated time remaining based on the difference, the controller comprising a trained classifier, the trained classifier generating a first estimated time remaining, said controller further comprising a post processing block determining an average standard deviation and a standard deviation for the first estimated time remaining, the post processing block generating the estimated time remaining as the first estimated time remaining when the standard deviation is below the average standard deviation or a previous estimated time remaining less a time since the previous estimated time remaining, the trained classifier comprising a recurrent neural network, the recurrent neural network comprising a plurality of weights that are changed by a trainer based on a mean absolute error and the trained classifier is disposed in a controller disposed remotely from the laundry appliance.

In yet another aspect of the disclosure, a laundry appliance includes a rotatable drum defining a laundry compartment therein and a drying system including drying ductwork for carrying drying air from an air inlet to the laundry compartment and from the laundry compartment to an outlet duct. The drying system includes a heater positioned to heat the drying air transported through the outlet duct. A first sensor device is positioned near the air inlet to measure an inlet humidity ratio for the drying air entering the air inlet. A second sensor device positioned near the outlet duct to measure an exhaust temperature. A third sensor device is positioned near the outlet duct to measure an exhaust humidity ratio for the drying air exiting the outlet duct. A controller is programmed to turn on the heater to initiate a drying cycle and turn off the heater to end the drying cycle. The controller is arranged in communication with a sequential recurrent neural network that uses machine learning to predict an estimated time remaining (ETR) value based on elapsed time, the exhaust temperature measured by the second sensor device, and a calculated difference (delta) between the exhaust humidity ratio measured by the second sensor device and the inlet humidity ratio measured by the first sensor device as inputs. The controller causes the display to display the estimated time remaining.

Advantageously, the estimated time remaining is more accurately determined based upon the various sensors described above. Further, outlying predictions may be ignored during a calculation cycle to make the system even more accurate.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is diagrammatic representation of a dryer according to the present disclosure.

FIG. 2 is a block diagrammatic view of the controller of FIG. 1.

FIG. 3 is a flowchart of a method for training the classifier of FIG. 2.

FIG. 4 is a flowchart of a method for operating and displaying the estimated

time remaining.

FIG. 5A is a plot of predicted versus actual or true values of the estimated time remaining along with outliers not considered or displayed.

FIG. 5B is a detailed diagrammatic view of a post processing process for modifying the estimated time remaining for a drying cycle.

### DETAILED DESCRIPTION

Referring to the Figures, wherein like numerals indicate corresponding parts throughout the several views, various aspects of a combination laundry appliance or a dryer laundry appliance 10 are illustrated.

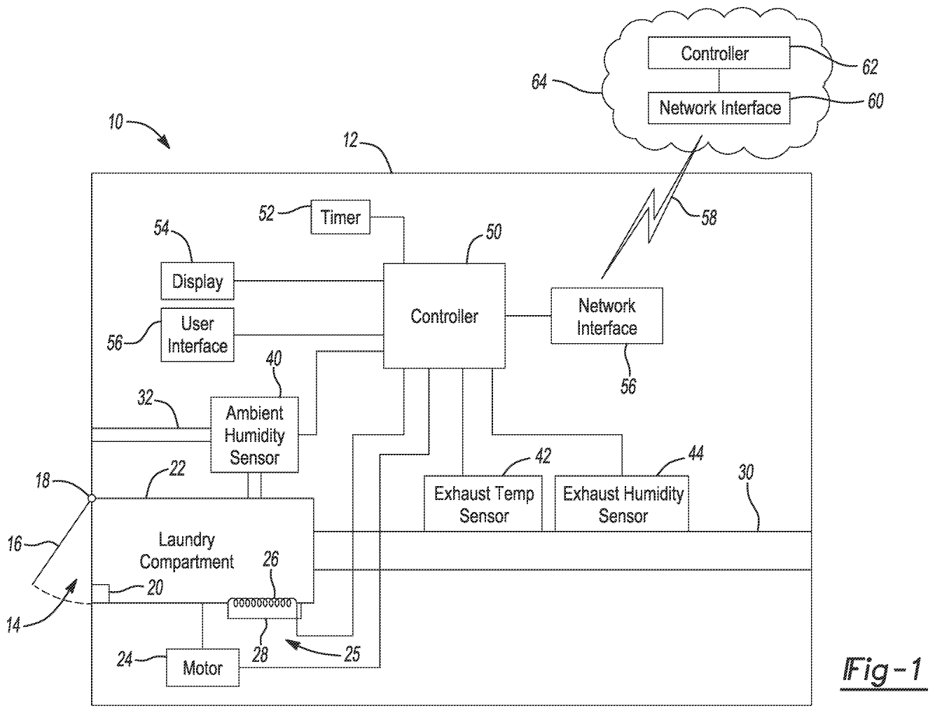

Referring now to FIG. 1, a laundry appliance 10 includes a cabinet 12 that is rectangular in shape and that includes a front opening 14. A front appliance door 16 is pivotally connected to the laundry appliance 10. The front appliance door 16 swings between an open position and a closed position. In the closed position, the front appliance door 16 shuts or closes the front opening 14 in the cabinet 12. Although other configurations are possible, in the illustrated example, the front appliance door 16 is pivotally mounted to the front of the cabinet 12 by a hinge 18 and held in the closed position during wash and drying cycles by a latch 20.

The laundry appliance 10 includes a laundry compartment 22. The laundry compartment 22 may be a rotatable drum that spins under the control of a motor 24. The laundry compartment 22 may also have a drying system 25 with a heater 26 for heating the air within the laundry compartment 22 to dry the clothing therein. The drying system 25 has heater 26 disposed in drying air ductwork including an air circulation duct 28. Although other configurations are possible, the heater 26 may be an electric resistant heater that has heating coils. During a drying cycle, the heater 26 operates to heat air inside the air circulation duct 28 or within the laundry compartment 22. The heater 26 is upstream of an outlet duct 30 of the drying system 25 that is used to transport the moist warm air from the laundry compartment 22. An intake duct 32 is used as an air inlet to communicate outside air into the circulation duct 28 to be heated by the heater 26.

An ambient humidity sensor 40 is disposed within the intake duct 32 and generates an ambient humidity signal 40 that has data that corresponds to the ambient humidity around the laundry appliance 10. The ambient humidity may be referred to as an inlet humidity ratio since the sensor provides a ratio of the amount of moisture in the air relative to dry air. For example, the number of kilograms of water relative to one kilogram of dry air may be provided by the ambient humidity sensor 40. Of course, other types of relative measures may be provided by the ambient humidity sensor 40.

An exhaust temperature sensor 42 is coupled to the outlet duct 30. The exhaust temperature sensor 42 provides data corresponding to the exhaust temperature within the outlet duct 30.

An exhaust humidity sensor 44 is also coupled to the outlet duct 30. The exhaust humidity sensor 44 generates an exhaust humidity signal that has data corresponding to the humidity in the outlet duct 30. The exhaust humidity sensor 44 may generate a ratio of the exhaust humidity versus dry air in a similar manner to the ambient humidity sensor 40. That is, a ratio of the mass of water within one kilogram of dry air may be provided by the exhaust humidity sensor 44.

A controller 50 comprises one or more microprocessors that are programmed to perform various functions as will be described in greater detail below. The controller 50 is in communication with the ambient humidity sensor 40, the exhaust temperature sensor 42 and the exhaust humidity sensor 44. The signals received by the controller 50 from the sensors 40, 42, 44 are used to calculate an estimated time remaining. The estimated time remaining may also be generated in response to a timer 52 that is used for timing a time period such as the time from the start of a drying cycle. The timer 52 may initiate the turning on off of the heater 26 and to end a drying cycle.

The controller 50 may also be in communication with a display 54 that is used to display the estimated time remaining.

A user interface 56 such as button, switches or dials is used for inputting various information to the controller 50. The user interface 56 may also comprise a touch panel or touch screen. The user interface 56 may be used to initiate a drying cycle and select the type of drying cycle from a plurality of drying cycle types such as normal, heavy-duty, permanent press, towels, bedding and the like.

The controller 50, as will be described below, contain a neural network for processing and determining the estimated time remaining. However, the controller 50 may also be coupled to a network interface 56 that communicates signals through a network 58 to a network interface 60 associated with a controller 62 located in a cloud 64 remote from the controller 50. The network 58 may be a wired or wireless network and may include the Internet. The cloud 64 is a plurality of remote servers that act as a controller used for processing data. That is, the amount of processing capacity available at the controller 50 may be limited and therefore the data may be transmitted through the network interfaces 56 through the network 58 and to the controller 62 through the network interface 60 for processing. The controller 62 may send control signals back to the controller 50 such as the estimated time remaining. Ultimately, the controller 50 causes the display 54 to display the estimated time remaining.

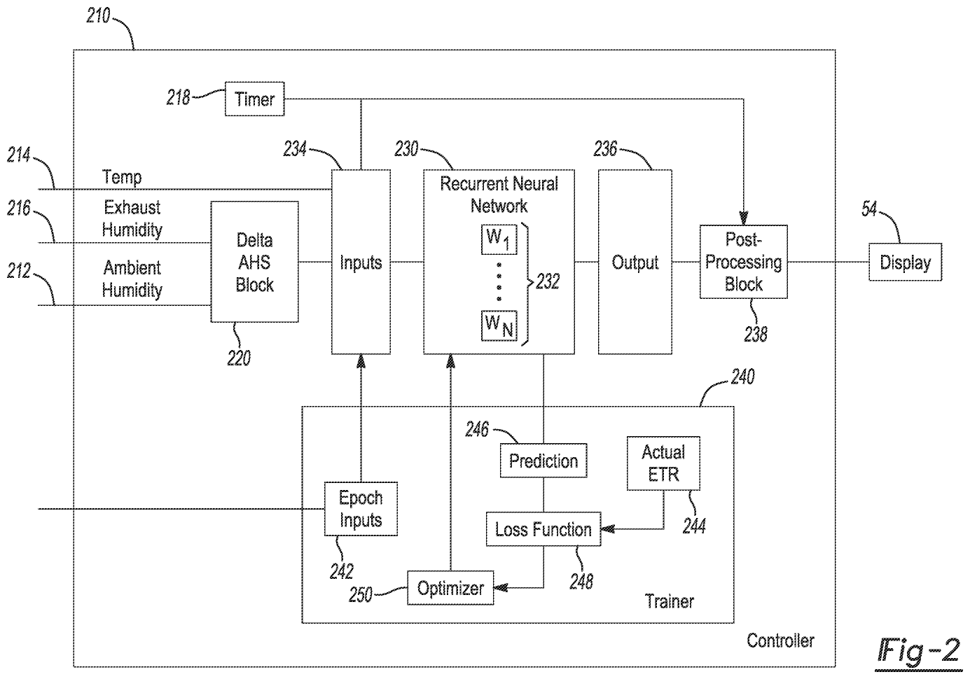

Referring now to FIG. 2, a controller such as the controller 50 or the controller 62 is set forth in further detail. The controller 210 receives the ambient humidity signal 212, the exhaust temperature signal 214 and the exhaust humidity signal 216. The timer 218, in this example, is disposed within the controller 210. However, the timer may also be a separate timer, such as the timer 52 illustrated in FIG. 1.

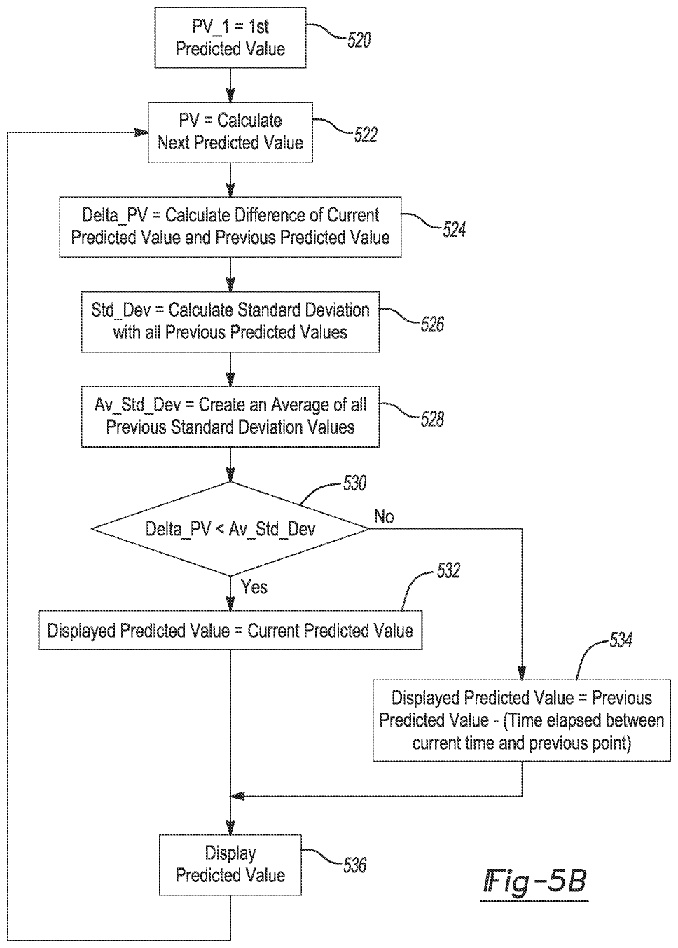

The ambient humidity signal 212 and the exhaust humidity signal 216 are communicated to a delta of absolute humidity ratio block (Delta AHS) 220. The Delta AHS block 220 determines the difference between the exhaust humidity and the ambient humidity based upon the exhaust humidity signal 216 and the ambient humidity signal 212. A sequential recurrent neural network 230 is a trained classifier having a plurality of weights 232 therein. The number of weights and the number of layers within the recurrent neural network is determined by design choice. A plurality of inputs 234 receive the timer signal from the timer 218, or timer 52 of FIG. 1, the temperature signal 214, and the Delta AHS signal 220. The signals to the recurrent neural network 230 which are used to calculate an output 236. The output 236 corresponds to the estimated time remaining in this example. A post processing block 238 may process the estimated time remaining from the output 236 prior to displaying the estimated time remaining at the display 54. The post processing block 238, in general, may ensure that the output is within a reasonable range and if not, a previous estimated time remaining less the amount of lapsed time since the last calculation may be generated at the display 54. Details of the post processing block will be provided below relative to FIGS. 5A and 5B.

In general, when the recurrent neural network 230 is started, a set of weights 232 is randomly provided therein. A trainer 240 is used to train the weights 232 using back propagation and determining an error or loss. During training, a plurality of epochs 242 are provided to the input 234 and processed through the recurrent neural network 230. In general, it has been found that the Delta AHS, the exhaust temperature and the timer together may be used to determine the estimated time remaining. The amount of humidity alone, as mentioned above, does not provide a good estimation of the estimated time remaining. By using these variables, the load of clothing within the laundry compartment is compensated for. That is, the recurrent neural network 230 may be trained with data in the epochs 242 that correspond to various amounts of moisture and various weights of clothing within the laundry compartment. The main difference between various load sizes is the time it takes to reach some of the temperature and relative humidity values.

The output 236 may be provide a rectified linear unit output. Other types of outputs 236 may be include a sigmoid output.

The trainer 240 has a number of inputs that are used to train the weights 232 of the recurrent neural network 230. Ultimately, the epoch inputs 242 have an actual estimated time remaining 244 associated therewith. The recurrent neural network 230 generates a prediction 246 based upon each of the inputs of the epochs 242. A loss function compares the actual estimated time remaining and the prediction 246 from the recurrent neural network 230. The loss function 248 used in the present example is mean absolute error (MAE) loss function may be used. In general, to the mean absolute error all of absolute errors are determined, the absolute errors are added and divide by the number of errors. For this example, the mean absolute error determines the deviation between the actual value and the predicted value to determine and error in the prediction 246. In the present example, the mean absolute error may be determined in the amount of seconds of deviation. The current error is compared to mean absolute error with various epochs representing various weights of clothing. For example, 10,000 epochs may be performed at 2 kgs, 4 kgs and 6 kilograms using 64 nodes of weights 232 within the recurrent neural network with a plurality of hidden layers such as 3, 4 or 6. Ultimately, the means absolute error may be provided to an optimizer 250 to determine how far the current error is from the mean absolute error. The optimizer 250 may be used to change the attributes such as the weights and the learning rate of the neural network 230 to reduce the losses or the amount of deviation from the actual value. In this example, the optimizer 250 uses an adaptive algorithm such as the adaptive moment estimation (ADAM). The ADAM optimizer works with momentums of both first and second orders. The general idea behind the ADAM process is to allow the weights to change but not so fast that minimum deviation is exceeded. Essentially, the velocity of change is decreased so that the weights are changed gradually during the epochs. In this example specifically, The current value of estimated time remaining is disregard (weights of the neural network not changed), if the current ETR is outside a range.

In general, three different types of epoch inputs 242 are used to train neural networks. At first, raw datasets are provided. A second dataset having the original training dataset and test dataset is provided such as at an 80% to 20% ratio. Thereafter, a training dataset may be used with a validation dataset at an 80% to 20% ratio.

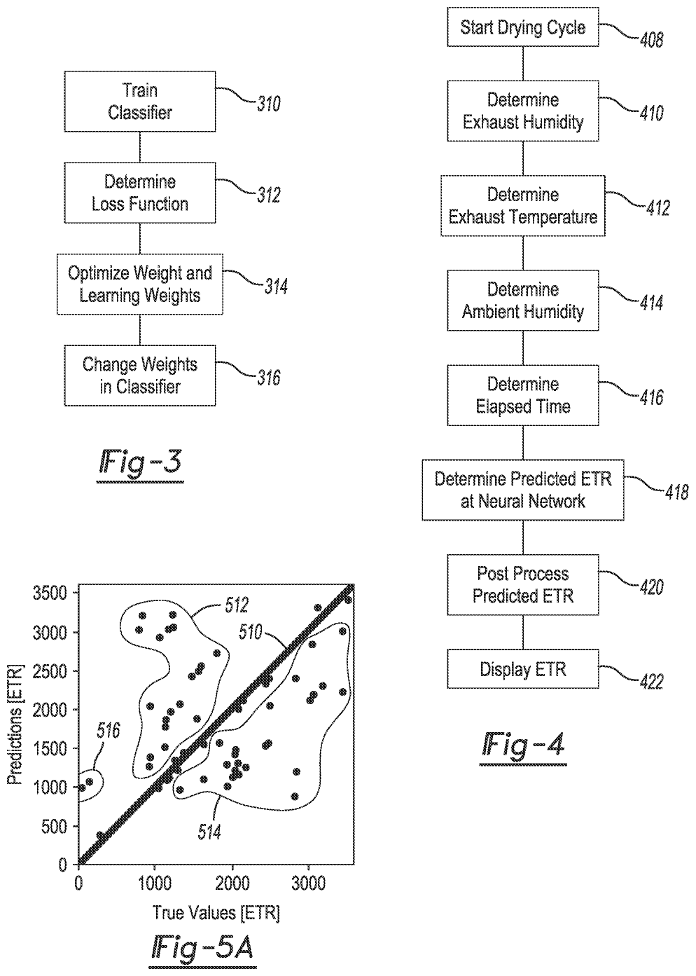

Referring now to FIG. 3, the operation of the training function is set forth in a high-level flowchart. In step 310, the classifier is trained by providing a plurality of epochs thereto. During the training process, loss functions are determined in step 312. The weights are learned in step 314 and ultimately optimized as mentioned above. The weights in the classifier are changed in step 316.

Referring now to FIG. 4, a method for operating the controller to display an estimated time remaining of a drying cycle is set forth. In step 408, the drying cycle is initiated, which may start the timer. In step 410, the exhaust humidity is determined by the exhaust humidity sensor. The exhaust humidity may be a ratio of the moisture versus dry air or the ratio the mass of moisture in the moist air compared to the mass of dry air. In step 412, the exhaust temperature is determined. The exhaust temperature is the temperature in the exhaust vent of the dryer during the dryer cycle. In step 414, the ambient humidity is determined by the ambient humidity sensor. As mentioned above, the ambient humidity may be the ambient moisture in the intake air or proximate the laundry appliance 10. In step 416, the elapsed time since the start of the drying cycle may also be determined. The elapsed time of the drying cycle is determined by the timer.

In step 418, a predicted elapsed time remaining is determined based on the sensors at the neural network in the controller. The exhaust humidity and the ambient humidity may be used or a difference (Delta) of the exhaust humidity ratio and the ambient humidity ratio may be used. Further the temperature of the exhaust and the elapsed time in the drying cycle may be used. As mentioned above, the controller may be remote and have the sensors signals or data communicated thereto through the network. Thereafter, step 420 may provide processing for the predicted estimated time remaining as will be described in more detail in FIGS. 5A and 5B.

In step 422, the display may display the estimated time remaining. The estimated time remaining may be the processed time from the post-processing or from the predicted estimate time remaining in step 418.

Referring now to FIG. 5A, a plot of prediction of the estimated time remaining versus the true or actual values of the estimated time remaining is set forth. The ideal plot at 510 illustrates exact correlation. Predicted determinations outside of the range of the line 510 are outliers that have been incorrected predicted. The correctly predicted estimated time remain are provided by the boundaries 512, 514 and 516. The post-processing block 238 described above performs a process to prevent the predictions within the boundaries 512, 514, and 516 from being displayed at the display. The standard deviation in real time is used for all of the predicted points over time. After that, the predicted value is compared versus the previous value using the current means standard deviation as described below in FIG. 5B in more detail.

Referring now to FIG. 5B, step 520 determines a first predicted value. In step 522, the next predicted value at some time later. Both step 520 and 522 are performed at the recurrent neural network 230 described above. In step 524, a change in the predicted value (Delta_PV) is determined by calculating the difference of the current predicted value (PV) and the previous predicted value (PV_1) is determined.

In step 526, the standard deviation is determined for all the previous predicted values. In step 528, the average standard deviation is determined by creating an average of all the previous standard deviation values. In step 530, the difference of the current and previous predicted value (Delta_PV) compared to the average standard deviation. When the Delta PV is less than the average standard deviation, step 532 the displayed predicted value is determined as the current predicted value PV.

In step 530, when the difference between the current predicted value and the previous predicted value is not less than the average standard deviation calculated in step 528, step 534 determines the displayed predicted value as the previous predicted value in step 520 minus the time elapsed between the current time and the time that that the previous predicted value in step 522 was determined.

After steps 532 and 534, the displayed predicted value is displayed on the display 54 of the laundry appliance 10 as the estimated time remaining in step 536.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

For purposes of description herein the terms “up,” “down,” “above,” “below,” “upper,” “lower,” “top,” “bottom,” “front,” “rear,” and derivatives thereof shall relate to the assembly as oriented in a typical installation. However, it is to be understood that the apparatus and assemblies described herein may assume various alternative orientations. Finally, the term “substantially” as used herein describes angles and/or orientations that can vary plus or minus five degrees from the referenced direction, axis, plane, or orientation.

Many modifications and variations of the apparatus and assemblies described in the present disclosure are possible in light of the above teachings and may be practiced otherwise than as specifically described while within the scope of the appended claims. These antecedent recitations should be interpreted to cover any combination in which the inventive novelty exercises its utility.

What is claimed is:

1. A laundry appliance, comprising:
a cabinet having a laundry compartment located inside said cabinet;
an exhaust vent extending from the laundry compartment;
an exhaust temperature sensor disposed in the exhaust vent generating an exhaust temperature signal;
an exhaust humidity sensor disposed in the exhaust vent generating an exhaust humidity signal;
an ambient humidity sensor generating an ambient humidity signal;
a display; and
a controller coupled to the exhaust temperature sensor, the exhaust humidity sensor and the ambient humidity sensor, said controller determining an estimated time remaining for a drying cycle based on the exhaust temperature signal, the exhaust humidity signal and the ambient humidity signal and causing the display to display the estimated time remaining.

2. The laundry appliance of claim 1 further comprising a timer generating an elapsed time since starting of the drying cycle and wherein the controller determines the estimated time remaining based on the elapsed time.

3. The laundry appliance of claim 1 wherein the exhaust humidity sensor generates an exhaust humidity signal corresponding to an exhaust humidity ratio and the ambient humidity sensor generates an ambient humidity signal corresponding to an inlet humidity ratio.

4. The laundry appliance of claim 3 wherein the controller generates a difference of the exhaust humidity ratio and the ambient humidity ratio and determines the estimated time remaining based on the difference.

5. The laundry appliance of claim 4 wherein the controller comprises a trained classifier.

6. The laundry appliance of claim 5 wherein the trained classifier generates a first estimated time remaining, said controller further comprising a post processing block determining an average standard deviation and a standard deviation for the first estimated time remaining, said post processing block generating the estimated time remaining as the first estimated time remaining when the standard deviation is below the average standard deviation or a previous estimated time remaining less a time since the previous estimated time remaining.

7. The laundry appliance of claim 5 wherein the trained classifier comprises a recurrent neural network.

8. The laundry appliance of claim 7 wherein the recurrent neural network comprises a plurality of weights that are changed by a trainer based on a mean absolute error.

9. The laundry appliance of claim 5 wherein the trained classifier is disposed in a controller disposed remotely from the laundry appliance.

10. A method of operating a laundry appliance having a laundry compartment and an exhaust vent extending from the laundry compartment, said method comprising generating an exhaust temperature signal from an exhaust temperature sensor disposed in the exhaust vent;
generating an exhaust humidity signal from an exhaust humidity sensor disposed in the exhaust vent;
generating an ambient humidity signal from an ambient humidity signal;
determining an estimated time remaining for a drying cycle based on the exhaust temperature signal, the exhaust humidity signal and the ambient humidity signal; and
displaying the estimated time remaining on a display.

11. The method of claim 10 further comprising generating, at a timer, an elapsed time since starting of the drying cycle and wherein determining the estimated time remaining based on the elapsed time.

12. The method of claim 10 wherein generating the exhaust humidity signal comprises generating an exhaust humidity ratio and wherein generating the ambient humidity signal comprises generating an ambient humidity ratio.

13. The method of claim 12 further comprising generating a difference of the exhaust humidity ratio and the ambient humidity ratio at a controller and generating the estimated time remaining based on the difference.

14. The method of claim 10 wherein determining the estimated time remaining comprises determining the estimated time remaining in a trained classifier.

15. The method of claim 10 further comprising generating a first estimated time remaining, determining an average standard deviation and a standard deviation for the first estimated time remaining in a post processing block, generating, in the post processing block, the estimated time remaining as the first estimated time remaining when the standard deviation is below the average standard deviation, or a previous estimated time remaining less a time since the previous estimated time remaining.

16. The method of claim 10 wherein determining the estimated time remaining comprises determining the estimated time remaining in a recurrent neural network.

17. The method of claim 16 wherein the recurrent neural network comprises a plurality of weights that are changed by a trainer based on a mean absolute error.

18. The method of claim 10 further comprising communicating the exhaust temperature signal, the exhaust humidity signal, and the ambient humidity signal to a trained classifier remote from a controller and determining the estimated time remaining in the trained classifier remote from the controller.

19. A laundry appliance comprising:
a rotatable drum defining a laundry compartment therein;
a drying system including drying ductwork for carrying drying air from an air inlet to the laundry compartment and from the laundry compartment to an outlet duct, the drying system including a heater positioned to heat the drying air transported through the outlet duct;
a first sensor device positioned near the air inlet to measure an inlet humidity ratio for the drying air entering the air inlet;
a second sensor device positioned near the outlet duct to measure an exhaust temperature;
a third sensor device positioned near the outlet duct to measure an exhaust humidity ratio for the drying air exiting the outlet duct;
a display; and
a controller programmed to turn on the heater to initiate a drying cycle and turn off the heater to end the drying cycle,
wherein the controller is arranged in communication with a sequential recurrent neural network that uses machine learning to predict an estimated time remaining (ETR) value based on elapsed time, the exhaust temperature measured by the second sensor device, and a calculated difference (delta) between the exhaust humidity ratio measured by the second sensor device and the inlet humidity ratio measured by the first sensor device as inputs;
wherein said controller causes the display to display the estimated time remaining.

20. The laundry appliance of claim 19 wherein the controller is disposed remotely from the laundry appliance.
